(19) United States
(12) Patent Application Publication
(10) Pub. No.: US 2007/0010414 A1
(43) Pub. Date: Jan. 11, 2007

(54) Composition and method for cleaning firearms

(75) Inventors: Kenneth R. Cioletti, Wayne, NJ (US); Ronald Wilen, Paramus, NJ (US)

Correspondence Address: KATTEN MUCHIN ROSENMAN LLP, 575 MADISON AVENUE, NEW YORK, NY, 10022-2585, US

(73) Assignee: United Energy Corporation

(21) Appl. No.: 11/339,014

(22) Filed: Jan. 25, 2006

Related U.S. Application Data
(63) Continuation-in-part of application No. 10/643,289, filed on Aug. 19, 2003.
Application No. 10/643,289 is a division of application No. 09/671,701, filed on Sep. 28, 2000, now Pat. No. 6,630,428.

(51) Int. Cl. C11D 7/32; C11D 3/20; F41A 29/00; F41A 31/00

(52) U.S. Cl. 510/190; 510/362; 42/95

(57) ABSTRACT

The invention relates to compositions and methods for cleaning both smokeless powder and black powder firearms comprising about 10 to 99 wt % of a fatty acid alkyl ester blend and about 1 to 25 wt % of at least one alkyl glycol ether, and additives designed to enhance the solvency and cleaning properties of the composition.

This application is a continuation-in-part of U.S. Ser. No. 10/643,289, filed Aug. 19, 2003, now U.S. Patent Application Publication No. 2004/0087449, which is a division of U.S. Ser. No. 09/671,701, filed Sep. 28, 2000, now U.S. Pat. No. 6,630,428, the entire contents of each of which are incorporated herein by reference.

### BACKGROUND OF THE INVENTION

1. Field of the Invention

This invention relates to compositions and methods suitable for use in the removal and remediation of deposits from firearm surfaces. The composition and method are particularly suitable for removal of deposits such as black power residue, carbon, lead, copper and plastics from the surfaces of the bore and chamber of firearms that use smokeless powder or black powder. However, the composition and method are suitable for use on all types of firearms and is not limited by the type of action. Thus, the composition and method of use are suitable for bolt action, lever action, rolling block, muzzle loading and other types of firearm actions. The composition and method are suitable for both single shot rifles and pistols, magazine fed rifles and pistols (single shot, automatic or semiautomatic) and revolvers. The composition and method are also suitable for use with larger firearms, including heavy and light machine guns, artillery pieces such as mortars, howitzers, and other cannon, recoilless rifles, tank cannon, aircraft mounted guns, and the like. The composition and method are compatible with standard firearm cleaning equipment, such as brass, bronze, or stainless steel bore brushes and natural or synthetic fiber patches of suitable size. The composition is water emulsifiable, non-flammable, and biodegradable, and is derived from modified vegetable oils.

2. Description of Related Art

The invention in about the 9^{th} century, and the subsequent refinement of black powder soon led to the concept of using its properties as a propellant to propel a projectile at relatively high speed. The first devices to utilize this concept were simple metal tubes attached to long rods and held like a spear. The quality of the early powder was poor and these devices were almost impossible to aim and had little or no accuracy. The original black powder was made simply by mixing the powdered ingredients consisting of sulfur, charcoal, and potassium nitrate. The powder was loaded into wooden barrels and transported. Vibration would cause the ingredients to separate causing inconsistency in the powder. This necessitated remixing the powder before use or mixing the ingredients on site.

The original hand held tube was supplanted by larger caliber tubes called bombards, which at first were made of flats of iron held together with hoops. These devices, at first, fired rocks which were formed into round balls and later cast iron projectiles. As casting technology improved, the bombards were cast of bronze and mounted on movable carriages. As progress continued on large bore weapons, smaller hand held weapons were being further developed. Initially the powder in the barrel of the hand held firearm was ignited by hand with a fuze. This was improved by the match lock, which used a string soaked in salt peter, which burned slowly. Pulling a lever or trigger lowered the match into a pan containing fine black powder which ignited and transferred the flame into the barrel. Matchlock technology was followed by improvements such as the wheelock, flintlock, and cap and ball.

All of these firearms had one thing in common; they all used black powder, which left inorganic residue and carbon black deposits inside the barrel and on surfaces of the action. The cleaning method of choice for removing these deposits was to use hot soapy water and make sure the barrel was dry before firing. This method, while somewhat effective, would not efficiently remove any water-insoluble deposits, and was time consuming, rendering the firearm unusable for the time necessary to dry the barrel and/or action. In addition to leaving deposits on the internal surfaces of the firearm, black powder emitted large quantities of smoke when burned, causing problems with visibility for military gunners after only a few rounds had been fired.

During the nineteenth century, a new propellant was developed based on the nitration of cellulose (cotton). This propellant was known as “gun-cotton” or nitro-cellulose or smokeless powder. The powder was smokeless because the combustion products it yields are predominantly gaseous, as compared to the approximately 60% solid products produced from combustion of black powder. Smokeless powder can be conveniently categorized as “single based” (almost pure nitrocellulose), “double based” (up to 50% of the powder composition is nitroglycerin), and “triple based” (nitrocellulose, nitroglycerin, and nitroguanidine). The powder composition is generally formed into small balls, cylinders, or flakes. The size and shape of the powder particles can be varied according to the bore size, projectile size, and desired projectile velocity. For example, powder used in artillery applications, where both bore and projectile are large, will contain large sized powder particles. Pistol ammunition contains very small sized particles.

In addition to reducing obscuring smoke, smokeless powder provided a significant increase in projectile muzzle velocity when compared to black powder. This, in turn, allowed for flatter projectile trajectories, and more accurate fire. The increased power also allowed for less powder in cartridges, making these lighter, so more ammunition could be transported more easily. Smokeless powder was more likely to ignite even when wet, as compared to black powder. Finally, decreased (and noncorrosive) residue deposited during combustion of smokeless powder contributed to the development of autoloading firearms, since the decreased residue resulted in decreased jamming of the autoloading action.

Although the new propellant itself left less residue than black powder and although the propellant residue was generally non-corrosive and non-hygroscopic (unlike black powder), other problems occurred. The primers that were used to ignite the powder charge left a residue that was corrosive to the metal surfaces of the bore and the action. The use of unjacketed lead bullets at higher velocity left larger lead deposits in the barrel. The smokeless powder was capable of producing higher velocities than black powder, and as bullet velocity increased, unjacketed lead bullets became less practical due to these deposits. New bullets were developed that had a lead core and jackets made of copper alloys. This reduced or eliminated lead fouling, but the jacketed bullets driven at higher velocities caused copper fouling. To remove corrosive residues, special cleaners were developed, and the old method of using hot water was reinstituted, followed by the use of cleaners capable of removing the copper fouling and powder residue.

Nitrocellulose based propellants are widely used in conventional, modern firearms, and are known by the names “ballistite” and “cordite.” Nevertheless, a significant market for black powder firearms exists, particularly among the hunting community. In fact, several states have different or extended hunting seasons for certain varieties of game for those using muzzle loading black powder firearms.

Currently, manufacturers of firearm cleaning compositions generally formulate and sell separate products, having different formulations, for cleaning black power and smokeless powder residues. For example, Hoppe's sells Hoppe's 9 Plus, which is believed to be a water-based formulation for use in firearms using black powder, but sells Hoppe's 9, which is believed to contain organic solvents and ammonia for cleaning smokeless powder firearms. The need to maintain separate product formulations for different types of firearms creates difficulties and expense that could be avoided if a single formulation was effective for both smokeless and black powder. For example, separate regulatory and documentation issues arise for each. Separate expenses must be made to market and brand each formulation, and separate inventories at the wholesale and retail level are necessary. In addition, consumers who use and maintain both types of firearms must purchase each type of cleaning composition, and ensure that each is used on the correct firearm. For these and other reasons, there remains a need in the art for a cleaning composition that can be used effectively with both black powder and smokeless powder firearms.

In addition, compositions for cleaning firearms have, in the past, relied upon the use of trihalohydrocarbon solvents, such as 1,1,1-trichloroethane. Since 1994, cleaning compositions containing 1,1,1-trichloroethane have been banned by the EPA as potentially carcinogenic. Accordingly, there remains a need in the art for firearm cleaning compositions that avoid this material, as well as other halogenated hydrocarbon solvents. In addition, there remains a need in the art for firearm cleaning compositions that avoid the use of many aromatic and aliphatic hydrocarbons, which are thought to be potentially carcinogenic, as well as alkaline compounds, which have the potential to burn, if mishandled. Cleaning compositions containing high VOC levels can also degrade plastic grips or other polymeric parts of firearms. Other firearm cleaning compositions contain ammonia, which, while it will effectively remove copper deposits from jacketed ammunition, will also degrade the finish of nickel-plated firearms, such as handguns. Accordingly, there remains a need in the art for cleaning compositions for firearms that contain low levels (if any) of VOC and ammonia, but that are effective at removing both black powder and smokeless powder deposits, as well as metal deposits, and that will, in addition, provide a protective coating to reduce the accumulation of deposits as the firearm is used in the future.

The most common uses of fatty acid alkyl ester blends are as industrial metal working lubricants, in soap manufacturing, as a plasticizer for waxes and as solvents in the formulation of industrial oils and leather treating. These compounds are also used as textile lubricants, foam depressants and as bio diesel fuel. The use of certain fatty acid alkyl ester blends in compositions for the removal of soils and scales from gas or oil production sites and equipment is disclosed in U.S. Pat. No. 6,630,428 and U.S. Patent Application Publication No. 2004/0087449. The use of such compositions to separate excess water or sludge from crude oil is disclosed in U.S. Pat. No. 6,620,620. The use of such compositions in fracing processes is disclosed in U.S. Pat. No. 6,260,621. None of these documents disclose or suggest the use of fatty acid alkyl ester blends for the removal of, or prevention of formation of, deposits in firearms.

### SUMMARY OF THE INVENTION

This invention relates to a cleaning composition and method that are equally effective in cleaning both black powder and smokeless powder residues. The composition is free of objectionable aromatic and aliphatic hydrocarbons, halogenated hydrocarbons, or alkaline cleaners.

In addition to its increased versatility, the composition and method of this invention provide increased safety when compared to many existing products. First, the composition and method of this invention are safer because of the decreased amount of volatile organic chemicals (VOC), which are present in amounts less than about 50% (considerably lower than many firearm cleaning compositions. Second, improved safety results from the elimination of halogenated, aromatic, and aliphatic hydrocarbon solvents, which have the potential for carcinogenicity. Third, the composition of the invention has a very high flash point (e.g., above 200° F.) and low rate of evaporation when compared to existing firearm cleaning compositions. This allows the composition to be safely applied at both ambient temperature (e.g., after a firearm has completely cooled) and at elevated temperature (e.g., before the firearm has completely cooled) with significantly decreased risk of ignition of the composition.

In addition to these benefits, the use the composition and method of the invention provides a protective effect by producing a coating on gun bores, chambers, and other metallic surfaces that helps to prevent the adhesion and accumulation of lead and copper fouling, helps to help retard corrosion, and helps to extend the time between cleanings, particularly in black powder firearms.

These and other advantages are obtained according to this invention by a liquid cleaning and protective composition and method for its use, wherein the composition contains fatty acid methyl esters and lower alkyl glycol ethers, and is effective in removing black powder and smokeless powder residues. More particularly, this invention relates to a composition comprising about 10 to about 99 wt % of a fatty acid alkyl ester blend and about 1 to about 25 wt % of at least one lower alkyl glycol ether, based on the total weight of the composition, and to methods for using this composition to remove and reduce build-up of residues resulting from firing projectiles using either black powder or smokeless powder.

In a more specific embodiment, the invention relates to a method for a cleaning firearms surface of either one of black powder residue, or smokeless powder residue, comprising:

(a) contacting the surfaces, or residue, or both with a sufficient amount of a cleaning composition to dissolve or loosen the black powder or smokeless powder residue, the cleaning composition comprising:
(1) about 10 wt % to about 99 wt % of a fatty acid alkyl ester blend; and
(2) about 1 wt % to about 25 wt % of at least one lower alkyl glycol ether; and

(b) removing the cleaning composition, any dissolved residue, and any loosened residue from the firearm surface.

In another particular embodiment, the invention relates to a method of reducing accumulation of residue from black powder, smokeless powder, projectile residue, or a combination thereof, on a firearm surface, comprising applying to the surface a coating of a composition comprising:

(1) about 10 wt % to about 99 wt % of a fatty acid alkyl ester blend; and (2) about 1 wt % to about 25 wt % of at least one lower alkyl glycol ether.

### DETAILED DESCRIPTION OF SPECIFIC EMBODIMENTS

The invention is directed toward compositions and methods for removing residues generated by firing munitions containing black powder or smokeless powder, by contacting the residues with the composition of the invention. In addition, the compositions of the invention can be applied in a method for reducing or preventing the build up of such residues by applying the composition to a surface where the residues are not yet present, but which surfaces are likely to be exposed to the powder and combustion products that form the residues. The cleaning composition of the invention comprises about 10 to 99% by weight of a fatty acid alkyl ester blend; and about 1 to 25% by weight of at least one lower alkyl glycol ether, with any balance comprising suitable additives. More particularly, the composition contains about 60 to 95% by weight, more particularly about 80 to 90% by weight, of the fatty acid alkyl ester blend, and preferably about 1 to 15% by weight of the lower alkyl glycol ether. All weight percentages are based on the total weight of the composition.

Fatty acid alkyl ester blends that have been found to be particularly suitable in compositions of the invention include those having C₁ to C₈ esters of C₄ to C₂₂ fatty acids. These fatty acid ester blends are typically derived from the esterification of fatty acids or the transesterification of animal fats or vegetable oils, but can also be produced by completely synthetic methods, according to techniques known in the chemical arts.

More particularly, the fatty acid alkyl ester blends suitable for use in the compositions and methods of this invention contain methyl, ethyl, n-propyl, isopropyl, or n-butyl esters of C₄ to C₂₂ fatty acids. In a particular embodiment, the fatty acid alkyl ester blend comprises methyl esters of C₄ to C₂₂ fatty acids. These fatty acid methyl ester blends are preferably blends with a cloud point of below about 40° F. and a high degree of unsaturation (generally having an iodine value of about 90 to about 130) to increase solvency. More particularly, the fatty acid methyl ester blends are derived from soya, canola, or other vegetable oils, or mixtures thereof, with a cloud point of 20-32° F. and iodine value of 90-130.

The compositions of the invention also contain about 1 to about 25 wt. % of a lower alkyl glycol ether, which functions as a penetrant, reduces viscosity of the mixture, functions as a coupling agent, and/or increases efficacy on hydrophilic soils. Examples of lower alkyl glycol ethers suitable for use in the present composition include, but are not limited to, dipropylene glycol monomethyl ether, tripropylene glycol monomethyl ether, ethylene and diethylene glycol ether, methyl, ethyl, propyl and butyl ethers, such as ethylene glycol monobutyl ether, or mixtures thereof.

In addition to the ester blend and the lower alkyl glycol ether, optional components may be included in composition of the invention, as indicated above. The description below is exemplary of such components, and not limitative.

Compositions of the invention may include one or more polyoxyalkylene glycol ethers in amounts of about 1 to about 40 wt. %, more particularly from about 3 to about 25 wt. %, and even more particularly from about 3 to about 10 wt. %. Polyethylene glycol ethers and polypropylene glycol ethers having the formulas:
R—−O—−(C₂H₄O)ₙH
and
R—−O—−(C₃H₆ 0)ₓH
where, in each formula, R is C₁ to C₈ alkyl and x is greater than 4, are particularly suitable Compositions where R is methyl, ethyl, propyl, or butyl are even more particularly suitable. More particularly, the polyoxyalkylene glycol ether is an n-butoxy polyalkylene glycol ether. Commercial polyoxyalkylene glycol ether formulations available include Macol 300, Macol 660, WSL-2000, WSL-3520, and WSL-5100 produced by PPG Mazer, Gurnee, Ill. The polyoxyalkylene glycol ether desirably has a molecular weight of between about 200 and 600 and a viscosity of between about 15 to 150 cps when measured at 25° C. using a Brookfield LVT Viscometer with a No. 2 spindle at 60 r.p.m.

At least 1 wt %, more particularly, 1.5 to 3 wt %, of antioxidants can be included in the compositions. Antioxidants suitable for the invention include, but are not limited to, (BHT) 2,6-di-tert-butyl-para-cresol, (BHA) 2,6di-tert-butyl-para-anisole, Eastman inhibitor O A B M-oxalyl bis (benzylidenehydrazide), and Eastman DTBMA2,5-di-tert-butylhydroquinone.

A surfactant may also be added to the composition. Any surfactant suitable for use in cleaning oily soils may be used, such as ethoxylated nonylphenols, linear alcohol ethoxylates, alkanolamine salts of dodecylbenzene sulfonic acid, sulfosuccinates, phosphate esters, alcohol sulfates, quaternary ammonium compounds, amphoteric surfactants, alpha-olefin sulfonates, sorbitan, and fatty acid derivatives. The surfactant is added in an amount effective to perform as a wetting agent and emulsifier, and usually up to 10 wt. %, more particularly 1-3 wt %, of the composition.

Up to 50 wt. % of other additives may be added, as needed, to modify particular properties, such as to vary the VOC levels, increase penetration of the mixture, decrease viscosity of the mixture, as couplers for solvents insoluble in the mixture, and to provide solvents for oleophilic and hydrophilic soils. It is within the skill of the art to determine the amount and type of additive needed for a particular application.

Suitable additives include terpenes, terpene alcohols, C₈-C₁₄ alcohol ester blends, glycols acid esters, diacid esters, amino acids, alkanolamines, and amines. Examples of terpenes include d-limonene and alpha. and beta. pinene and terpene alcohols, including a-terpineol. C.sub.8-C.sub14 alcohol ester blends include EXXATE 900, 1000, and 1300 from Exxon Chemical; glycols include propylene glycol, dipropylene glycol, and tripropylene glycol. Acid esters include methyl oleate and methyl linoleate, and diacid esters include methyl or butyl diesters of glutaric, adipic, and succinic acids. Petroleum hydrocarbons include AROMATIC 100, AROMATIC 150, ISOPAR M, and ISOPAR K.

Amines such as morpholene, 1,3-dimethyl-2-imidazolidinone, 1,3 propanediamine, 2-amino-1,3-propanediol, and 3-amino propanol, and alkanolamines such as triethanolamine, diethanolaine,2-aminomethyl propanol, and monoethanolamine can be added to act as dispersants for soils and to solubilize fatty acids and oils. Amino acids, such as choline and choline hydroxide, provide nontoxic alternatives to monoethanolamine, and can be added to act as metal chelators, preferably, methyl or isobutyl esters of C.sub.4-C.sub.6 aliphatic dibasic esters and n-methyl-2 pyrrolidone. Desirably, up to 5 wt % of n-methyl-2 pyrrolidone is included.

Other additives typically used in cleaning compositions may be also be included, such as water softening agents, sequesterants, and corrosion inhibitors, which are added in amounts effective to perform their intended function. Identification of suitable additives and amounts thereof are well within the skill of the art. Suitable water softening agents include linear phosphates, styrene-maleic acid copolymers, and polyacrylates. Suitable sequesterants include 1,3 dimethyl-2-imidazolidinone, 1-phenyl-3-isoheptyl-1,3-propanedione, and 2-hydroxy-5-nonylacetophenoneoxime. Examples of corrosion inhibitors include 2-aminomethyl propanol, diethylethanolamine benzotriazole, and methyl benzotriazole.

However, any additives preferably have a flash point greater than 190° F. TCC, and are added in quantities sufficient to achieve a final composition flash point greater than 200° F.

The composition of the invention is effective in removing inorganic residues, carbon, metal fouling, and polymer residues from the bore, chamber, and other surfaces of any firearm. The composition is compatible for use with commercially available cleaning equipment, such as cleaning rods, brass or stainless steel brushes and cotton or synthetic cleaning patches. In one embodiment of the method of the invention, deposits on bore, chamber, or action surfaces of firearms are removed by applying the composition described herein using a cloth or patch on a cleaning rod, or a brush on a cleaning rod, and wiping or brushing the deposit until it is removed.

In another embodiment of the method of the invention, the composition described herein is applied to clean surfaces of bore, chamber, or action surfaces of firearms to provide an effective coating thereon to prevent, reduce, or slow the buildup of soils, deposits, and corrosion. The composition is low evaporative and provides differential wetting of the surfaces; thus, the composition will not evaporate to any significant extent and it will provide a coating that remains on the surface for useful periods of time.

### EXAMPLES

In the following examples, the relative effectiveness of the formulation was determined by actual composition performance in the cleaning application.

### Example 1

The following composition (by weight) was blended:

| | |
|---|---|
| Fatty acid methyl ester | 60.0% |
| n-Butoxy polyalkylene glycol ether | 20.0% |
| Dipropylene glycol monomethyl ether | 5.0% |
| Butylcarbitol | 4.0% |
| Exxate 1000 (Exxon) | 3.0% |
| DBE (DuPont) | 3.0% |
| Tripropylene glycol monomethyl ether | 3.0% |
| d-Limonene | 1.0% |
| Nonylphenol 9.5 Mole E.O. | 1.0% |

At least 1 wt % of antioxidants selected from one or more BHT, BHA, and Eastman inhibitor OABM were also added.

### Example 2

The following composition was blended (by weight):

| | |
|---|---|
| Fatty acid methyl ester | 67.5% |
| n-Butoxy polyalkylene glycol ether | 20.0% |
| Ethylene glycol monobutyl ether | 4.5% |
| Diethylene glycol monobutyl ether | 1.0% |
| Dipropylene glycol monomethyl ether | 1.0% |
| Tripropylene glycol monomethyl ether | 1.0% |
| Exxate 900 (Exxon) | 1.0% |
| Exxate 1000 (Exxon) | 1.0% |
| 1-Methyl 2-pyrrolidinone | 1.0% |
| Dibasic esters | 1.0% |

At least 1 wt % of antioxidants selected from one or more of BHT, BHA, and Eastman inhibitor OABM were also added.

### Example 3

The following composition was blended (by weight):

| | |
|---|---|
| Fatty acid methyl ester | 86.0% |
| Nonylphenol (9.5 mole Ethylene Oxide) | 1.5% |
| Nonylphenol (6.0 mole Ethylene Oxide) | 1.5% |
| Ethylene glycol monobutyl ether | 1.0% |
| Diethylene glycol monomethyl ether | 1.0% |
| Dipropylene glycol monomethyl ether | 1.0% |
| Tripropylene glycol monomethyl ether | 1.0% |
| Exxate 900 (Exxon) | 1.0% |
| Exxate 1000 (Exxon) | 1.0% |
| Exxate 3000 (Exxon) | 1.0% |
| 1-Methyl 2-pyrrolidinone | 1.0% |
| Dibasic esters | 1.0% |

All three compositions were tested on both a smokeless powder rifle in 7 mm Remington Magnum and a .50 caliber in-line black powder rifle. Twenty consecutive shots were fired through each rifle, after which the rifles were cleaned by passing cloth patches soaked in the cleaning composition of Example 1, 2, or 3 until no residue was visible to the naked eye. A similar test was carried out using the commercially available firearm cleaning compositions Hoppe's #9, Hoppe's Elite, Breakfree CLP, and Outers Nitro Solvent Bore Cleaner.

In each case, significantly fewer patches were required to clean firearms surfaces that had been used to fire cartridges with the smokeless powder than were required to clean firearms with competitive products (three verses twenty patches). Cleaning of the firearm used with black powder, followed by coating the bore with a heavy coating of the composition of the invention resulted in more rounds being fired before fouling occurred (20-30 versus 5 to 10).

It will be apparent to those skilled in the art that various modifications and variations can be made in the compositions and methods of the present invention without departing from the spirit or scope of the invention. Thus, it is intended that the present invention cover the modifications and variations of this invention provided they come within the scope of the appended claims and their equivalents.

What is claimed is:

1. A method for a cleaning firearms surface of either one of black powder residue, or smokeless powder residue, comprising:
(a) contacting the surfaces, or residue, or both with a sufficient amount of a cleaning composition to dissolve or loosen the black powder or smokeless powder residue, the cleaning composition comprising:
(1) about 10 wt % to about 99 wt % of a fatty acid alkyl ester blend; and
(2) about 1 wt % to about 25 wt % of at least one lower alkyl glycol ether; and
(b) removing the cleaning composition, any dissolved residue, and any loosened residue from the firearm surface.

2. The method of claim 1, wherein the surfaces comprise a firearm bore, a firearm chamber, or a firearm action.

3. The method of claim 1, wherein the fatty acid alkyl ester blend comprises one or more C₁ to C₈ esters of one or more C₄ to C₂₂ fatty acids.

4. The method of claim 3, wherein the fatty acid alkyl ester blend comprises one or more esters that are methyl, ethyl, n-propyl, isopropyl, or n-butyl esters of one or more C₄ to C₂₂ fatty acids.

5. The method of claim 4, wherein the fatty acid alkyl ester blend comprises (3) one or more methyl esters of one or more C₄ to C₂₂ fatty acids.

6. The method of to claim 1, wherein the lower alkyl glycol ether is selected from the group consisting of ethylene glycol monobutyl ether, diethylene glycol monobutyl ether, dipropylene glycol monomethyl ether, tripropylene glycol monomethyl ether, and mixtures thereof.

7. The method of claim 1, wherein the cleaning composition further comprises about 1 wt % to about 40 wt % of one or more polyoxyalkylene glycol ethers.

8. The method of claim 7, wherein the one or more polyoxyalkylene glycol ethers are selected from the group consisting of:
RO(C₂H₄O)ₓH
and
RO(C₃H₆O)ₙH
wherein R is C₁ to C₈ alkyl and x is greater than 4.

9. The method of claim 8, wherein R is methyl, ethyl, propyl, or butyl.

10. The method of claim 9, wherein the polyoxyethylene glycol ether is n-butoxypolyalkylene glycol ether.

11. The method of claim 1, wherein the cleaning composition further comprises (4) up to 20 wt % of at least one additive selected from the group consisting of terpenes, terpene alcohols, C₈-C₁₄ alcohol acetate blends, glycols, diacid esters, and petroleum hydrocarbons.

12. The method of claim 1, wherein the cleaning composition further comprises (5) up to 10 wt % of one or more surfactants.

13. The method of claim 12, wherein the surfactant is selected from the group consisting of ethoxylated nonylphenols, linear alcohol ethoxylates, and alkanolamine salts of dodecylbenzene sulfonic acid.

14. The method of claim 1, wherein the cleaning composition further comprises at least about 1 wt % of an antioxidant.

15. The method of claim 1, wherein the fatty acid alkyl ester blend is present an amount ranging from about 50 wt % to about 95 wt %.

16. The method of claim 1, wherein the same cleaning composition can remove both black powder and smokeless powder reside.

17. A method of reducing accumulation of residue from black powder, smokeless powder, projectile residue, or a combination thereof, on a firearm surface, comprising applying to the surface a coating of a composition comprising:
(1) about 10 wt % to about 99 wt % of a fatty acid alkyl ester blend; and
(2) about 1 wt % to about 25 wt % of at least one lower alkyl glycol ether.
